(19) United States
(12) Patent Application Publication
(10) Pub. No.: US 2024/0073027 A1
(43) Pub. Date: Feb. 29, 2024

(54) SYSTEM FOR PROVIDING NON-FUNGIBLE TOKEN ACCESS TO A USER

(71) Applicant: Verilink Corporation, ANN ARBOR, MI (US)

(72) Inventors: Isaac Dubuque, ANN ARBOR, MI (US); Nico Ramirez, ANN ARBOR, MI (US)

(73) Assignee: Verilink Corporation, ANN ARBOR, MI (US)

(21) Appl. No.: 17/896,242

(22) Filed: Aug. 26, 2022

(51) Int. Cl. H04L 9/32; G06K 19/077

(52) U.S. Cl. CPC H04L 9/3247; G06K 19/07762

(57) ABSTRACT

At a high level, aspects of the present disclosure are directed to systems and methods for providing NFT access to a user. In an embodiment, an NFT integrated device may be configured to provide access to an NFT linked to a physical asset to a user through a digital tag.

### FIELD OF THE INVENTION

The present invention generally relates to the field of non-fungible tokens. In particular, the present invention is directed to a system for providing non-fungible token access to a user.

### BACKGROUND

Modern non-fungible tokens (NFTs) tend to be almost entirely linked to digital assets, leaving a barrier for entry of many physical assets. Accordingly, modern NFT technology can be improved.

### SUMMARY OF THE DISCLOSURE

In an aspect, a system for providing non-fungible token (NFT) access to a user is disclosed. A system includes an NFT integrated device. An NFT integrated device includes a physical asset, a digital tag linked to an NFT of the physical asset, and a securing mechanism coupling the digital tag into at least a portion of the physical asset. An NFT integrated device is configured to receive user input. An NFT integrated device is configured to verify user input as a function of a verification criterion. An NFT integrated device is configured to provide access to an NFT of a physical asset to a user as a function of a verification of user input.

In another aspect, a method of providing NFT access to a user is disclosed. A method includes providing an NFT integrated device. A method includes receiving user input through an NFT integrated device. A method includes verifying user input as a function of a verification criterion. A method includes providing access to an NFT linked to a physical asset of an NFT integrated device as a function of a verification of user input.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of a system for NFT access;

FIG. 2 is an exemplary embodiment of an NFT integrated device;

FIG. 3 is an illustration of an exemplary embodiment of an immutable sequential listing;

FIG. 4 is a flowchart of an exemplary method of providing NFT access to a user; and

FIG. 5 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for providing NFT access to a user. In an embodiment, an NFT integrated device may be configured to provide access to an NFT linked to a physical asset to a user through a digital tag.

Aspects of the present disclosure can be used to authenticate physical assets using blockchain, which may prevent counterfeiting of physical assets. Aspects of the present disclosure can also be used to transfer physical assets and digital assets linked to the physical assets among one or more users. This is so, at least in part, because physical assets may include a digital tag that may be linked to an NFT of the physical asset.

Aspects of the present disclosure allow for integrating physical assets with NFT technology. Exemplary embodiments illustrating aspects of the present disclosure are described below in the context of several specific examples.

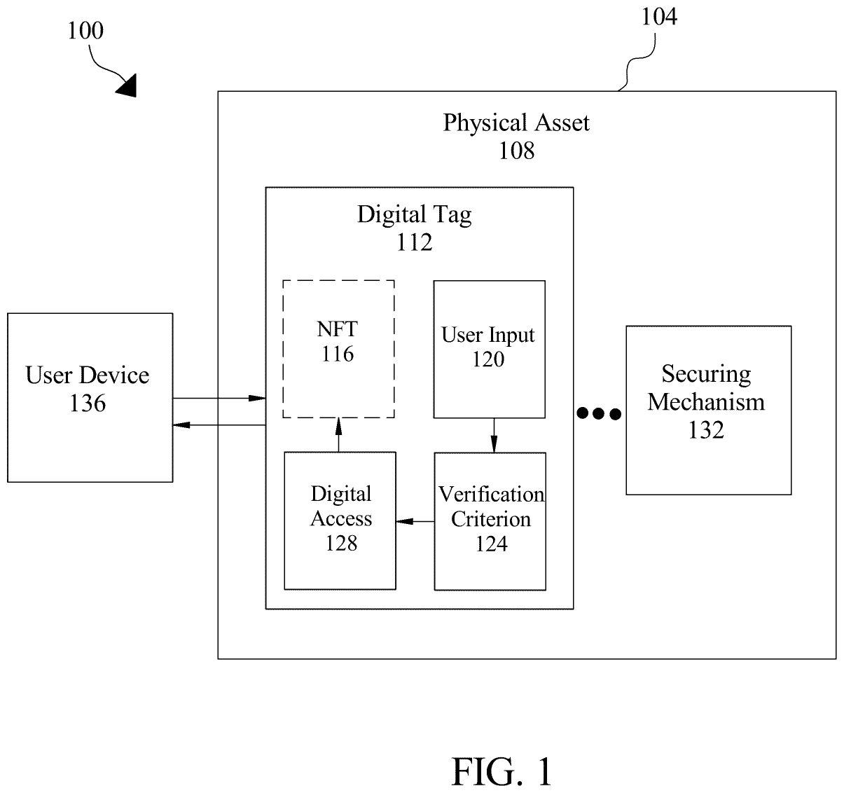

Referring now to FIG. 1, an exemplary embodiment of a system 100 for providing NFT access to a user through an NFT integrated device 104 is presented. System 100 may include NFT integrated device 104. An “NFT integrated device” as used in this disclosure is an object including data of an NFT. NFT integrated device 104 may include a computing device. NFT integrated device 104, digital tag 112, user device 136, and/or any other device described throughout this disclosure may include a computing device. A computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single computing device operating independently, or may include two or more computing device operating in concert, in parallel, sequentially or the like; two or more computing devices may be included together in a single computing device or in two or more computing devices. A computing device may interface or communicate with one or more additional devices as described below in further detail via a network interface device. Network interface device may be utilized for connecting a computing device to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. A computing device may include but is not limited to, for example, a computing device or cluster of computing devices in a first location and a second computing device or cluster of computing devices in a second location. A computing device may include one or more computing devices dedicated to data storage, security, distribution of traffic for load balancing, and the like. A computing device may distribute one or more computing tasks as described below across a plurality of computing devices of computing device, which may operate in parallel, in series, redundantly, or in any other manner used for distribution of tasks or memory between computing devices. A computing device may be implemented using a “shared nothing” architecture in which data is cached at the worker, in an embodiment, this may enable scalability of system 100 and/or computing device.

With continued reference to FIG. 1, a computing device may be designed and/or configured to perform any method, method step, or sequence of method steps in any embodiment described in this disclosure, in any order and with any degree of repetition. For instance, a computing device may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, in some embodiments, NFT integrated device 104 may include physical asset 108. A “physical asset” as used throughout this disclosure is an object having mass in the physical world. Physical asset 108 may include, without limitation, articles of clothing. “Articles of clothing” as used in this disclosure are one or more objects and/or materials worn by one or more individuals. Articles of clothing may include, without limitation, hats, shirts, sunglasses, shoes, coats, jackets, socks, gloves, watches, and the like. In some embodiments, physical asset 108 may include, without limitation, bags, purses, and/or other objects. Physical asset 108 may include one or more forms of art. A “form of art” as used in this disclosure is an object and/or combination of objects created for entertainment purposes. Forms of art may include, without limitation, paintings, sculptures, and the like. One of ordinary skill in the art will appreciate, upon reading this disclosure, the many various forms and structures physical asset 108 may include.

Still referring to FIG. 1, in some embodiments, physical asset 108 may include digital tag 112. A “digital tag” as used in this disclosure is any computing device configured to transmit and/or receive data that attaches to an object. Digital tag 112 may include, without limitation, near-field communication (NFC) tags, radio frequency identification (RFID) tags, Bluetooth devices, and the like. Digital tag 112 may be configured to operate at, without limitation, a frequency of between 1 MHz to 50 MHz. In some embodiments, digital tag 112 may include a high frequency NFC and/or RFID tags. High frequency NFC and/or RFID tags may be configured to operate at about 100 MHz to 1 GHz. Digital tag 112 may include, without limitation, a dual band antennae, single band antennae, and the like. In some embodiments, digital tag 112 may include a power source. A “power source” as used in this disclosure is a source of energy. A power source of digital tag 112 may include one or more batteries, capacitors, and/or other components that store electrical energy. In some embodiments, digital tag 112 may include a passive digital tag. A “passive digital tag” as used in this disclosure is a computing device coupled to an object that has no internal power supply. A passive tag may include, without limitation, passive NFC, passive RFID, and/or other passive tags.

Still referring to FIG. 1, in some embodiments, digital tag 112 may include one or more sensors. A “sensor” as used in this disclosure is a device capable of detecting natural phenomenon. A sensor of digital tag 112 may include, but is not limited to, accelerometers, pressure sensors, light sensors, temperature sensors, and the like. In some embodiments, digital tag 112 may include a touch sensor. A “touch sensor” as used in this disclosure is a device capable of detecting and/or measuring physical touch. A touch sensor may include, but is not limited to, capacitive touch sensors, resistive touch sensors, and the like. Digital tag 112 may utilize one or more touch sensors to receive user input 120. For instance, and without limitation, digital tag 112 may receive user input 120 in a form of physical touch received at a touch sensor of digital tag 112, such as a tap, swipe, and the like. In some embodiments, digital tag 112 may include one or more vibration elements. A “vibration element” as used in this disclosure is an electromechanical device capable of oscillation. Vibration elements may include, without limitation, brushless, eccentric rotating mass, linear resonant actuator, and/or other types of vibration motors. In some embodiments, digital tag 112 may utilize one or more vibration elements. In some embodiments, digital tag 112 may be configured to provide haptic feedback to a user. “Haptic feedback” as used in this disclosure is a process of conveying information to a user through one or more vibrations. Haptic feedback may include, but is not limited, long vibrations, short vibrations, frequent vibrations, vibration patterns, and the like. A “vibration pattern” as used in this disclosure is a repeating series of one or more vibrations. A vibration pattern may include, but is not limited to, triple taps, double taps, short vibration followed by long vibration, long vibration followed by short vibration, and the like. Haptic feedback may be used by digital tag 112 to convey one or more data elements of digital access 128 and/or NFT 116. For instance, and without limitation, a user may provide user input 120 through a touchpad of digital tag 112. User input 120 may not meet verification criterion 124, which may prevent a user from receiving digital access 128. Digital tag 112 may convey this information with three sequential strong vibrations. In another non-limiting example, digital tag 112 may convey user input 120 meets verification criterion 124 and that digital access 128 may be available, through two short, light vibrations.

Still referring to FIG. 1, in some embodiments, digital tag 112 may include one or more light emitting elements. A “light emitting element” as used in this disclosure is a device capable of reflecting and/or generating one or more photons. A light emitting element of digital tag 112 may include, without limitation, light emitting diodes (LEDS) and/or other light emitting devices. Digital tag 112 may include a plurality of light emitting elements positioned in a pattern, such as, but not limited to, circular, triangular, square, and the like. As a non-limiting example, digital tag 112 may include a square shape, which may include a light emitting element at each corner of a face of the square shape. Digital tag 112 may utilize a light emitting element to convey information about digital access 128 and/or NFT 116 to a user. As a non-limiting example, digital tag 112 may display a red light through one or more LEDs, which may indicate user input 120 failed to meet verification criterion 124. In another non-limiting example, digital tag 112 may display a blue, green, or other color to convey digital access 128 may be granted to a user.

Still referring to FIG. 1, digital tag 112, and/or any computing device described throughout this disclosure, may be configured to generate one or more signals. As used in this disclosure, a “signal” is any intelligible representation of data, for example from one device to another. A signal may include an optical signal, a hydraulic signal, a pneumatic signal, a mechanical, signal, an electric signal, a digital signal, an analog signal and the like. In some cases, a signal may be used to communicate with a computing device, for example by way of one or more ports. In some cases, a signal may be transmitted and/or received by a computing device for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 128 [printer port]), and the like.

Still referring to FIG. 1, in some cases, system 100 may perform one or more signal processing steps on a signal. For instance, system 100 may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

Still referring to FIG. 1, in some embodiments, digital tag 112 may be secured to physical asset 108 through securing mechanism 132. A “securing mechanism” as used in this disclosure is a device capable of removably attaching two or more objects together. Securing mechanism 132 may include, without limitation, stickers, glue, pins, clips, and the like. In some embodiments, securing mechanism 132 may include, without limitation, one or more fabrics. For instance, and without limitation, digital tag 112 may be sewn into physical asset 108, where securing mechanism 132 may include the fabric of the sewing of digital tag 112 to physical asset 108. Securing mechanism 132 may include a tamper proof element. A “tamper proof” element as used in this disclosure is one or more components that if removed irreversible damage an object. Tamper proof elements may include, without limitation, pins, adhesive substances, and/or other elements. Digital tag 112 may include a tamper proof element that may cause damage to NFT integrated device 104. Removing a tamper proof element of digital tag 112 may damage, without limitation, securing mechanisms, circuitry, materials, and/or other parts of NFT integrated device 104. For instance and without limitation, digital tag 112 may include a tamper proof element that may damage a circuitry of digital tag 112 if a user attempts to remove digital tag 112 from physical asset 108.

In some embodiments, digital tag 112 may include a secure computing module. As used herein, a “secure computing module” is a hardware element configured to perform one or more secured operations beyond the control of other circuit elements or software, whether incorporated with the secure computing module in a circuit or computing device, or a part of an extrinsic computing device. As a result, at least one secured operation performed by a secure computing module is intrinsically reliable; that is, the at least one secured operation may be relied upon by any other module or user to produce an expected result regardless of behavior by neutral or adversarial parties, as long as some basic set of assumptions hold true. Other parties may be able to assign a confidence level in a secure computing module and/or a system or computing device incorporating a secure computing module based on the above-described set of assumptions. As a non-limiting, example, a secure computing module designed to produce an expected result despite all software-only attacks may give rise to a first confidence level, whereas another secure computing module designed to produce its expected result in the face of all software or hardware attacks may give rise to a second confidence level; the second confidence level may be higher, owing to the reduced probability that the second secure computing module would be compromised.

Still viewing FIG. 1, a secure computing module of digital tag 112 may include a trusted platform module (TPM). In an embodiment, a TPM may include a hardware module, which may be an integrated circuit, an optoelectronic circuit, a section of an integrated circuit on the same die as a processor, an integrated circuit packaged with other die in a multi-chip module or other multi-die integration method, or printed circuit board product; a TPM may have any suitable elements of digital or analog circuitry usable to perform one or more processes as described herein, including without limitation processes used to determine confidence levels and/or authenticate digitally signed assertions as described below. A TPM may have memory and/or other logic and/or a processor in its own right which may be in a non-limiting example a crypto processor. A TPM may have a hard-coded process for signing a digital signature, which may be performed using a private key, which is associated with a public key. This private key and/or signing process may be produced using a genuinely random process during manufacturing, and/or unique object (UNO) fingerprint, and/or a physically unclonable function (PUF), or any other disorder-based security primitive, defined as a function that creates challenge responses from a physical circuit that depend on unique features of that circuit, including without limitation microstructure features or elements that depend on random physical factors occurring or conferred during manufacture. Private key may be extracted via physically unclonable function processes using, for instance, a fuzzy extractor or key extractor physically unclonable function. Private key extraction may utilize additional corrective measures, including as a nonlimiting example machine learning, neural networks, convolutional neural networks and the like, or other approaches to provide error correction over the operating temperature range of the device. Private key generation may additionally incorporate true random number generator(s) (TRNGs), pseudorandom number generators (PRNGs) and related devices.

With continued reference to FIG. 1, a TPM may include circuitry to generate one or more asymmetric key pairs according to a public key cryptosystem as described above, and/or to sign a digital circuit. A TPM may include one or more tamper-proofing designs or components to prevent reverse-engineering; for instance, and without limitation, a TPM may include metastable elements, such that it is not possible to predict the circuit behavior from a plan of the circuit, without electrically probing the circuit; one or more instances or subsections of the circuit may be disposed within a three-dimensional chip in a form that makes it infeasible to probe with drilling and/or thinning via chemical-mechanical polishing, grinding, etching or the like, or slicing the chip, and so arrayed that drilling and/or slicing and/or thinning via chemical-mechanical polishing, grinding, etching or the like will destroy the circuit sufficiently to make the PK impossible to recover. Random and/or physically unclonable functions may be used by the crypto-processor in the TPM to ensure that the manufacturer furthermore has no way of predicting how subsequent key-pairs can be generated. A TPM may be used for a DAA as disclosed in further detail below. A TPM may be implemented using any PKI system/asymmetrical system as described above, including without limitation RSA and elliptic curve PKI systems.

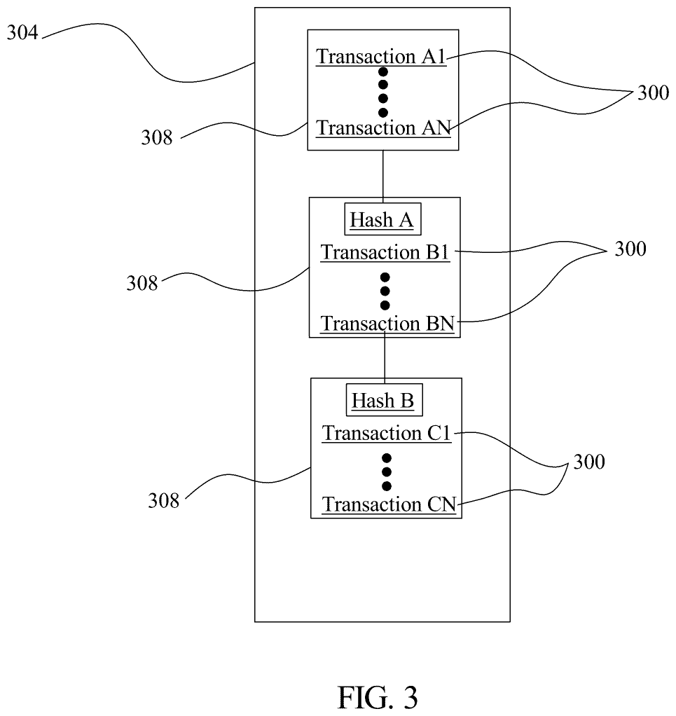

Still referring to FIG. 1, digital tag 112 may include non-fungible token (NFT) 116. An “NFT” as used in this disclosure is a cryptographic asset on a blockchain. NFT 116 may include, but is not limited to, one or more digital assets, such as digital representations of objects, art, videos, media files, and the like. In some embodiments, NFT 116 may be linked to physical asset 108. For instance and without limitation, NFT 116 may include a digital representation of physical asset 108. In some embodiments, NFT 116 may include data of proof of ownership of physical asset 108. NFT 112 may include one or more blockchains, as described below with reference to FIG. 3.

Still referring to FIG. 1, in some embodiments, digital tag 112 may include, without limitation, one or more processors, microprocessors, microcontrollers, and the like. In some embodiments, digital tag 112 may include a computing device as described above. Digital tag 112 may be configured to communicate with user device 136. A “user device” as used in this disclosure is any computing device operable by a user. User device 136 may include, without limitation, smartphones, tablets, laptops, smartwatches, and the like. In some embodiments, user device 136 may communicate with digital tag 112 through Bluetooth, Wi-Fi, and/or other forms of connection. Digital tag 112 may be configured to receive user input 120 from user device 136. “User input” as used in this disclosure, is data received from an individual. User input 120 may include, but is not limited to, selections of icons on a graphical user interface, swiping gestures, tapping gestures, and/or other forms of data input that may be entered through user device 136. For instance and without limitation, user device 132 may include a smartphone, and user input 120 may include one or more taps of a touch screen of the smartphone. In some embodiments, digital tag 112 may prompt user device 136 to communicate user input 120. Digital tag 112 may determine a proximity of user device 136. A “proximity” as used in this disclosure is a metric of position relative to an object. Proximity may be measured relative to digital tag 112. In other embodiments, proximity may be measured relative to user device 136. In some embodiments, digital tag 112 may compare a proximity of one or more devices, such as user device 136, to a proximity threshold, without limitation. A “proximity threshold” as used in this disclosure is a value or range of values that if met triggers an action. As a non-limiting example, user device 136 may be within 3 feet of digital tag 112, which may trigger digital tag 112 to prompt user device 136 to display a portion of a GUI for user input relating to digital tag 112.

Still referring to FIG. 1, in some embodiments, digital tag 112 and/or a computing device in communication with digital tag 112, may compare user input 120 to verification criterion 124. Digital tag 112 may be configured to connect to one or more external computing devices, cloud-networks, and the like. External computing devices, cloud-networks, and/or other computing devices in communication with digital tag 112 may be configured to validate user input 120 with verification criterion 124. In other embodiments, digital tag 112 may include a computing device capable of performing one or more tasks locally, such as, without limitation, comparing user input 120 to verification criterion 124. A “verification criterion” as used in this disclosure is a metric that if met authenticates data. Verification criterion 124 may include data of one or more digital signatures. For instance and without limitation, verification criterion 124 may include a specific digital signature generated from an authorized computing device. In some embodiments, verification criterion 124 may include one or more timestamps. A “timestamp” as used in this disclosure is a time corresponding to when an action took place. Timestamps may include, without limitation, seconds, minutes, hours, days, months, years, and the like. As a non-limiting example, a timestamp of user input 120 may be 5 seconds after a set window, which may render user input 120 invalid and/or unverified. In some embodiments, verification criterion 124 may include one or more distances, such as, without limitation, distances from a current owner of NFT 116, distances to physical asset 108, and the like. In some embodiments, verification criterion 124 may include one or more locations. Verification criterion 124 may include specific geographic coordinates, approximate locations, and/or other types of location metric. For instance, and without limitation, verification criterion 124 may include a geographical location of a specific sneaker store in Boston, MA. In other embodiments, verification criterion 124 may include a form of user identification. User identification may include, without limitation, one or more accounts, digital wallet addresses, usernames, and the like. In some embodiments, verification criterion 124 may include device identification, such as, without limitation, IP addresses, MAC addresses, IMEI numbers, ESN numbers, and the like. In some embodiments, verification criterion 124 may include user input patterns, such as, without limitation, user input frequency, time of user input, type of user input, and the like. For instance and without limitation, verification criterion 124 may include a user input pattern of triple tapping a touchscreen of user device 136, with about a second between each tap.

Still referring to FIG. 1, in some embodiments, verification criterion 124 may include one or more contingencies. A “contingency” as used in this disclosure is a future event and/or circumstance that if met triggers an action. Contingencies may include, but are not limited to, real-world events such as sporting events, which may include soccer, football, basketball, tennis, track, horse racing, and/or other sporting events. For instance, and without limitation, a contingency may include a specific team winning a football game. Digital tag 112 and/or user device 136 may communicate with one or more external computing devices to verify one or more contingencies, without limitation. In some embodiments, verification criterion 124 may include data relating to one or more value quantifiers. A “value quantifier” as used in this disclosure is a token corresponding to a numerical value. Value quantifiers may include, but are not limited to, fiat currencies, crypto currencies, and the like. For instance and without limitation, verification criterion 124 may include a value quantifier of 1 Bitcoin, $2,000, and the like. A user may distribute one or more value quantifiers to one or more entities, which may grant the user digital access 128 to NFT 116. Contingencies may be programmed into digital tag 112. In other embodiments, contingencies may be generated at an external computing device and digital tag 112 may communicate contingencies with the external computing device. Verification criterion 124 may include a combination of any verification criterion described throughout this disclosure, without limitation, which may improve security of distribution of digital access 128.

Still referring to FIG. 1, as used in this disclosure, “verification” is a process of ensuring that which is being “verified” complies with certain constraints, for example without limitation system requirements, regulations, and the like. In some cases, verification may include comparing a product, such as user input 120 and or digital signatures, without limitation, against one or more acceptance criteria. For example, in some cases, user input 120 may be required to meet one or more verification criterion 124. In some cases, verification may include ensuring that data is complete, for example that all required data types, are present, readable, uncorrupted, and/or otherwise useful. In some cases, some or all verification processes may be performed by a computing device in communication with digital tag 112. In some embodiments, at least one of validation and/or verification includes without limitation one or more of supervisory validation, graph-based validation, geometry-based validation, and rules-based validation.

Still referring to FIG. 1, in an embodiment, methods and systems described herein may perform or implement one or more aspects of a cryptographic system. In one embodiment, a cryptographic system is a system that converts data from a first form, known as “plaintext,” which is intelligible when viewed in its intended format, into a second form, known as “ciphertext,” which is not intelligible when viewed in the same way. Ciphertext may be unintelligible in any format unless first converted back to plaintext. In one embodiment, a process of converting plaintext into ciphertext is known as “encryption.” Encryption process may involve the use of a datum, known as an “encryption key,” to alter plaintext. Cryptographic system may also convert ciphertext back into plaintext, which is a process known as “decryption.” Decryption process may involve the use of a datum, known as a “decryption key,” to return the ciphertext to its original plaintext form. In embodiments of cryptographic systems that are “symmetric,” decryption key is essentially the same as encryption key: possession of either key makes it possible to deduce the other key quickly without further secret knowledge. Encryption and decryption keys in symmetric cryptographic systems may be kept secret and shared only with persons or entities that the user of the cryptographic system wishes to be able to decrypt the ciphertext. One example of a symmetric cryptographic system is the Advanced Encryption Standard (“AES”), which arranges plaintext into matrices and then modifies the matrices through repeated permutations and arithmetic operations with an encryption key.

Still referring to FIG. 1, in embodiments of cryptographic systems that are “asymmetric,” either encryption or decryption key cannot be readily deduced without additional secret knowledge, even given the possession of a corresponding decryption or encryption key, respectively; a common example is a “public key cryptographic system,” in which possession of the encryption key does not make it practically feasible to deduce the decryption key, so that the encryption key may safely be made available to the public. An example of a public key cryptographic system is RSA, in which an encryption key involves the use of numbers that are products of very large prime numbers, but a decryption key involves the use of those very large prime numbers, such that deducing the decryption key from the encryption key requires the practically infeasible task of computing the prime factors of a number which is the product of two very large prime numbers. Another example is elliptic curve cryptography, which relies on the fact that given two points P and Q on an elliptic curve over a finite field, and a definition for addition where A+B=−R, the point where a line connecting point A and point B intersects the elliptic curve, where “0,” the identity, is a point at infinity in a projective plane containing the elliptic curve, finding a number k such that adding P to itself k times results in Q is computationally impractical, given correctly selected elliptic curve, finite field, and P and Q.

Still referring to FIG. 1, in some embodiments, systems and methods described herein produce cryptographic hashes, also referred to by the equivalent shorthand term “hashes.” A cryptographic hash, as used herein, is a mathematical representation of a lot of data, such as files or blocks in a block chain as described in further detail below; the mathematical representation is produced by a lossy “one-way” algorithm known as a “hashing algorithm.” Hashing algorithm may be a repeatable process; that is, identical lots of data may produce identical hashes each time they are subjected to a particular hashing algorithm. Because hashing algorithm is a one-way function, it may be impossible to reconstruct a lot of data from a hash produced from the lot of data using the hashing algorithm. In the case of some hashing algorithms, reconstructing the full lot of data from the corresponding hash using a partial set of data from the full lot of data may be possible only by repeatedly guessing at the remaining data and repeating the hashing algorithm; it is thus computationally difficult if not infeasible for a single computer to produce the lot of data, as the statistical likelihood of correctly guessing the missing data may be extremely low. However, the statistical likelihood of a computer of a set of computers simultaneously attempting to guess the missing data within a useful timeframe may be higher, permitting mining protocols as described in further detail below.

Still referring to FIG. 1, in an embodiment, hashing algorithm may demonstrate an “avalanche effect,” whereby even extremely small changes to lot of data produce drastically different hashes. This may thwart attempts to avoid the computational work necessary to recreate a hash by simply inserting a fraudulent datum in data lot, enabling the use of hashing algorithms for “tamper-proofing” data such as data contained in an immutable ledger as described in further detail below. This avalanche or “cascade” effect may be evinced by various hashing processes; persons skilled in the art, upon reading the entirety of this disclosure, will be aware of various suitable hashing algorithms for purposes described herein. Verification of a hash corresponding to a lot of data may be performed by running the lot of data through a hashing algorithm used to produce the hash. Such verification may be computationally expensive, albeit feasible, potentially adding up to significant processing delays where repeated hashing, or hashing of large quantities of data, is required, for instance as described in further detail below. Examples of hashing programs include, without limitation, SHA256, a NIST standard; further current and past hashing algorithms include Winternitz hashing algorithms, various generations of Secure Hash Algorithm (including “SHA-1,” “SHA-2,” and “SHA-3”), “Message Digest” family hashes such as “MD4,” “MD5,” “MD6,” and “RIPEMD,” Keccak, “BLAKE” hashes and progeny (e.g., “BLAKE2,” “BLAKE-256,” “BLAKE-512,” and the like), Message Authentication Code (“MAC”)-family hash functions such as PMAC, OMAC, VMAC, HMAC, and UMAC, Poly1305-AES, Elliptic Curve Only Hash (“ECOH”) and similar hash functions, Fast-Syndrome-based (FSB) hash functions, GOST hash functions, the Grøstl hash function, the HAS-160 hash function, the JH hash function, the RadioGatún hash function, the Skein hash function, the Streebog hash function, the SWIFFT hash function, the Tiger hash function, the Whirlpool hash function, or any hash function that satisfies, at the time of implementation, the requirements that a cryptographic hash be deterministic, infeasible to reverse-hash, infeasible to find collisions, and have the property that small changes to an original message to be hashed will change the resulting hash so extensively that the original hash and the new hash appear uncorrelated to each other. A degree of security of a hash function in practice may depend both on the hash function itself and on characteristics of the message and/or digest used in the hash function. For example, where a message is random, for a hash function that fulfills collision-resistance requirements, a brute-force or “birthday attack” may to detect collision may be on the order of O(2^{n/2}) for n output bits; thus, it may take on the order of 2²⁵⁶ operations to locate a collision in a 512 bit output “Dictionary” attacks on hashes likely to have been generated from a non-random original text can have a lower computational complexity, because the space of entries they are guessing is far smaller than the space containing all random permutations of bits. However, the space of possible messages may be augmented by increasing the length or potential length of a possible message, or by implementing a protocol whereby one or more randomly selected strings or sets of data are added to the message, rendering a dictionary attack significantly less effective.

Continuing to refer to FIG. 1, a “secure proof,” as used in this disclosure, is a protocol whereby an output is generated that demonstrates possession of a secret, such as device-specific secret, without demonstrating the entirety of the device-specific secret; in other words, a secure proof by itself, is insufficient to reconstruct the entire device-specific secret, enabling the production of at least another secure proof using at least a device-specific secret. A secure proof may be referred to as a “proof of possession” or “proof of knowledge” of a secret. Where at least a device-specific secret is a plurality of secrets, such as a plurality of challenge-response pairs, a secure proof may include an output that reveals the entirety of one of the plurality of secrets, but not all of the plurality of secrets; for instance, secure proof may be a response contained in one challenge-response pair. In an embodiment, proof may not be secure; in other words, proof may include a one-time revelation of at least a device-specific secret, for instance as used in a single challenge-response exchange.

Still referring to FIG. 1, a secure proof may include a zero-knowledge proof, which may provide an output demonstrating possession of a secret while revealing none of the secret to a recipient of the output; zero-knowledge proof may be information-theoretically secure, meaning that an entity with infinite computing power would be unable to determine secret from output. Alternatively, zero-knowledge proof may be computationally secure, meaning that determination of secret from output is computationally infeasible, for instance to the same extent that determination of a private key from a public key in a public key cryptographic system is computationally infeasible. Zero-knowledge proof algorithms may generally include a set of two algorithms, a prover algorithm, or “P,” which is used to prove computational integrity and/or possession of a secret, and a verifier algorithm, or “V” whereby a party may check the validity of P. Zero-knowledge proof may include an interactive zero-knowledge proof, wherein a party verifying the proof must directly interact with the proving party; for instance, the verifying and proving parties may be required to be online, or connected to the same network as each other, at the same time. Interactive zero-knowledge proof may include a “proof of knowledge” proof, such as a Schnorr algorithm for proof on knowledge of a discrete logarithm. in a Schnorr algorithm, a prover commits to a randomness r, generates a message based on r, and generates a message adding r to a challenge c multiplied by a discrete logarithm that the prover is able to calculate; verification is performed by the verifier who produced c by exponentiation, thus checking the validity of the discrete logarithm. Interactive zero-knowledge proofs may alternatively or additionally include sigma protocols. Persons skilled in the art, upon reviewing the entirety of this disclosure, will be aware of various alternative interactive zero-knowledge proofs that may be implemented consistently with this disclosure.

Alternatively, and with continued reference to FIG. 1, a zero-knowledge proof may include a non-interactive zero-knowledge, proof, or a proof wherein neither party to the proof interacts with the other party to the proof; for instance, each of a party receiving the proof and a party providing the proof may receive a reference datum which the party providing the proof may modify or otherwise use to perform the proof. As a non-limiting example, zero-knowledge proof may include a succinct non-interactive arguments of knowledge (ZK-SNARKS) proof, wherein a “trusted setup” process creates proof and verification keys using secret (and subsequently discarded) information encoded using a public key cryptographic system, a prover runs a proving algorithm using the proving key and secret information available to the prover, and a verifier checks the proof using the verification key; public key cryptographic system may include RSA, elliptic curve cryptography, ElGamal, or any other suitable public key cryptographic system. Generation of trusted setup may be performed using a secure multiparty computation so that no one party has control of the totality of the secret information used in the trusted setup; as a result, if any one party generating the trusted setup is trustworthy, the secret information may be unrecoverable by malicious parties. As another non-limiting example, non-interactive zero-knowledge proof may include a Succinct Transparent Arguments of Knowledge (ZK-STARKS) zero-knowledge proof. In an embodiment, a ZK-STARKS proof includes a Merkle root of a Merkle tree representing evaluation of a secret computation at some number of points, which may be 1 billion points, plus Merkle branches representing evaluations at a set of randomly selected points of the number of points; verification may include determining that Merkle branches provided match the Merkle root, and that point verifications at those branches represent valid values, where validity is shown by demonstrating that all values belong to the same polynomial created by transforming the secret computation. In an embodiment, ZK-STARKS does not require a trusted setup.

Still referring to FIG. 1, a zero-knowledge proof may include any other suitable zero-knowledge proof. Zero-knowledge proof may include, without limitation bulletproofs. Zero-knowledge proof may include a homomorphic public-key cryptography (hPKC)-based proof. Zero-knowledge proof may include a discrete logarithmic problem (DLP) proof. Zero-knowledge proof may include a secure multi-party computation (MPC) proof. Zero-knowledge proof may include, without limitation, an incrementally verifiable computation (IVC). Zero-knowledge proof may include an interactive oracle proof (TOP). Zero-knowledge proof may include a proof based on the probabilistically checkable proof (PCP) theorem, including a linear PCP (LPCP) proof. Persons skilled in the art, upon reviewing the entirety of this disclosure, will be aware of various forms of zero-knowledge proofs that may be used, singly or in combination, consistently with this disclosure.

With continued reference to FIG. 1, in an embodiment, secure proof is implemented using a challenge-response protocol. In an embodiment, this may function as a one-time pad implementation; for instance, a manufacturer or other trusted party may record a series of outputs (“responses”) produced by a device possessing secret information, given a series of corresponding inputs (“challenges”), and store them securely. In an embodiment, a challenge-response protocol may be combined with key generation. A single key may be used in one or more digital signatures as described in further detail below, such as signatures used to receive and/or transfer possession of crypto currency assets; the key may be discarded for future use after a set period of time. In an embodiment, varied inputs include variations in local physical parameters, such as fluctuations in local electromagnetic fields, radiation, temperature, and the like, such that an almost limitless variety of private keys may be so generated. Secure proof may include encryption of a challenge to produce the response, indicating possession of a secret key. Encryption may be performed using a private key of a public key cryptographic system, or using a private key of a symmetric cryptographic system; for instance, trusted party may verify response by decrypting an encryption of challenge or of another datum using either a symmetric or public-key cryptographic system, verifying that a stored key matches the key used for encryption as a function of at least a device-specific secret. Keys may be generated by random variation in selection of prime numbers, for instance for the purposes of a cryptographic system such as RSA that relies prime factoring difficulty. Keys may be generated by randomized selection of parameters for a seed in a cryptographic system, such as elliptic curve cryptography, which is generated from a seed. Keys may be used to generate exponents for a cryptographic system such as Diffie-Helman or ElGamal that are based on the discrete logarithm problem.

Still referring to FIG. 1, a “digital signature,” as used herein, includes a secure proof of possession of a secret by a signing device, as performed on provided element of data, known as a “message.” A message may include an encrypted mathematical representation of a file or other set of data using the private key of a public key cryptographic system. Secure proof may include any form of secure proof as described above, including without limitation encryption using a private key of a public key cryptographic system as described above. Signature may be verified using a verification datum suitable for verification of a secure proof; for instance, where secure proof is enacted by encrypting message using a private key of a public key cryptographic system, verification may include decrypting the encrypted message using the corresponding public key and comparing the decrypted representation to a purported match that was not encrypted; if the signature protocol is well-designed and implemented correctly, this means the ability to create the digital signature is equivalent to possession of the private decryption key and/or device-specific secret. Likewise, if a message making up a mathematical representation of file is well-designed and implemented correctly, any alteration of the file may result in a mismatch with the digital signature; the mathematical representation may be produced using an alteration-sensitive, reliably reproducible algorithm, such as a hashing algorithm as described above. A mathematical representation to which the signature may be compared may be included with signature, for verification purposes; in other embodiments, the algorithm used to produce the mathematical representation may be publicly available, permitting the easy reproduction of the mathematical representation corresponding to any file.

Still referring to FIG. 1, in some embodiments, digital signatures may be combined with or incorporated in digital certificates. In one embodiment, a digital certificate is a file that conveys information and links the conveyed information to a “certificate authority” that is the issuer of a public key in a public key cryptographic system. Certificate authority in some embodiments contains data conveying the certificate authority's authorization for the recipient to perform a task. The authorization may be the authorization to access a given datum. The authorization may be the authorization to access a given process. In some embodiments, the certificate may identify the certificate authority. The digital certificate may include a digital signature.

With continued reference to FIG. 1, in some embodiments, a third party such as a certificate authority (CA) is available to verify that the possessor of the private key is a particular entity; thus, if the certificate authority may be trusted, and the private key has not been stolen, the ability of an entity to produce a digital signature confirms the identity of the entity and links the file to the entity in a verifiable way. Digital signature may be incorporated in a digital certificate, which is a document authenticating the entity possessing the private key by authority of the issuing certificate authority and signed with a digital signature created with that private key and a mathematical representation of the remainder of the certificate. In other embodiments, digital signature is verified by comparing the digital signature to one known to have been created by the entity that purportedly signed the digital signature; for instance, if the public key that decrypts the known signature also decrypts the digital signature, the digital signature may be considered verified. Digital signature may also be used to verify that the file has not been altered since the formation of the digital signature. In other embodiments where trust in a single certificate authority is undesirable (e.g., where there is concern of the certificate authority and verifier colluding), the same functionality may be accomplished by a group of certificate authorities acting to authenticate in coordination, with the requirement that a threshold number of the group of certificate authorities, and/or a threshold proportion of the group of certificate authorities, agree (e.g. “threshold cryptography”); a confidence level in each certificate authority may be determined according to any method or means described herein for determination of a confidence level in any device or entity, including without limitation in a remote device as described in further detail below. In an embodiment, certificate authorities that have a confidence level below a given threshold level may be eliminated; in other embodiments, certificate authority confidence levels may be aggregated according to any method shown herein. Aggregate confidence level may be used for threshold cryptography as described above; for instance, agreeing certificate authorities may have an aggregate confidence level which must exceed a threshold, or aggregate confidence level of agreeing certificate authorities may be required to represent a threshold proportion of aggregate confidence level of all certificate authorities in group. Additional embodiments may include group signature schemes that issue certificates on a membership public key generated by a secure computing module as described in further detail below; in such scenarios, authentication may include proof by the secure computing module that the secure computing module possesses a secret key to a public key/certificate pair. Although digital signatures have been introduced here as performed using public key cryptographic systems, digital signatures may alternatively or additionally be performed using any non-interactive zero-knowledge proof; for instance, a proof may be recorded in conjunction with a datum, and a verification may be performed by any party seeking to evaluate the proof.

Still referring to FIG. 1, in some embodiments, digital tag 112 and/or user device 136 may be configured to communicate with one or more nodes of a network. A network may include one or more cryptographic evaluators. A “cryptographic evaluator” as used in this disclosure is a computing device configured to participate in one or more processes associated with a temporally sequential listing. A cryptographic evaluator may be designed and configured to participate in or practice one or more processes described herein for creation, modification, and/or authentication of temporally sequential listing, portions or sublistings thereof, and/or transactions. A network may be connected to digital tag 112 and/or user device 136, and information may be distributed throughout the network, in any suitable way. As a non-limiting example, a network may be a centralized network, where all nodes in the network, including without limitation all cryptographic evaluators, send their data to and receive their data from, a central node (i.e. a server), so that communications by all non-central nodes are mediated by or through the central node. As a further non-limiting example, a network may be a distributed network wherein each node may be connected to and communicate with any other node; nodes not directly connected may transmit messages to and from one another via intermediate nodes, for instance by “hopping” messages from one node to another. A network may include a decentralized network, having a plurality of local centralized nodes that connect to one another, such that “non-centralized” nodes connect only via local centralized nodes, or connections between locally centralized nodes. A network may include a “federated” network. Persons skilled in the art, upon reviewing the entirety of this disclosure, will be aware of various forms and/or configurations of a network may take consistently with the disclosed systems and methods.

With continued reference to FIG. 1, in an embodiment, a temporally sequential listing may be copied and/or provided in its entirety to a cryptographic evaluator. Alternatively or additionally, a temporally sequential listing may be copied to some cryptographic evaluators but not to others; for instance, where the temporally sequential listing is a block chain or a consensus ledger created for exchanges of virtual currency or other commercial exchanges, the temporally sequential listing may be copied to all cryptographic evaluators participating in such exchanges. In other embodiments still, various components of temporally sequential listings may be distributed to various computing devices, such as cryptographic evaluators in a network. In other embodiments still, subcomponents of a complete temporally sequential listing may be distributed to various computing devices in a network, such that a group of computing devices, such as cryptographic evaluators, may each have a copy of the same subcomponent, and in totality, all subcomponents making up the complete temporally sequential listing that may be contained in the network. Distribution of devices having a copy of the same subcomponent of a temporally sequential listing may be optimized locally in network graph space and/or geographical space, for example as described in further detail below. Where a temporally sequential listing is centralized, computing devices that do not possess a copy of the temporally sequential listing may obtain information from and convey information to the temporally sequential listing by communicating with the computing device or set of computing devices on which the centralized temporally sequential listing is maintained. Where temporally sequential listing is decentralized and multiple copies of the entire temporally sequential listing are distributed to multiple computing devices, computing devices that do not possess a copy of the temporally sequential listing may obtain information from and convey information to a copy of the temporally sequential listing residing on a computing device that does have a copy; requests for information and changes to the temporally sequential listing may be propagated to all other computing devices having copies of the temporally sequential listing.

Still viewing FIG. 1, digital tag 112 may be connected to a network. In an embodiment, digital tag 112 may be a cryptographic evaluators in a network. Digital tag 112 may store locally an instance of a temporally sequential listing to be authenticated by one or more cryptographic evaluators. Alternatively or additionally, digital tag 112 may be referring to an instance of a temporally sequential listing stored on one or more cryptographic evaluators. In some embodiments, digital tag 112 may not itself be a cryptographic evaluator.

Still referring to FIG. 1, systems and methods as described herein may involve computation, calculation, assessment, assignment, or use of a confidence level associated with one or more processes, devices, or data, including without limitation one or more processes, appraisals, and/or cryptographic evaluators as described herein. Confidence level, as used herein, is an element of data expressing a degree to which the safety, security, or authenticity of a process, device, or datum may be relied upon. As used herein, a confidence level may include a numerical score; numerical score may be a score on a scale having one extremum representing a maximal degree of reliability, and a second extremum representing a minimum degree of liability. As a non-limiting example, extremum representing maximal degree of reliability may be a maximal number of an ordered set of numbers such as an open or closed set on the real number line, a sequential listing of integers or natural numbers, or the like; persons skilled in the art will be aware that selection of a numerical extremum to represent a higher level of confidence or reliability, albeit intuitively pleasing, is not mathematically necessary, and any suitable mapping of level of confidence or reliability to numerical objects or ranges may feasibly be substituted. As a further non-limiting example, numerical score may include, or be mappable to, a probability score, such as a percentage probability or a 0-1 probability level. Confidence level may include further information or indications, such as without limitation flags denoting untrustworthy, suspect, or hostile elements; for instance a flag may indicate that a particular device, program, process, or element of data appears to be compromised and/or has been involved in fraudulent or otherwise hostile or disruptive engagement with system 100 and/or methods described herein in the past. Methods of aggregating, computing, and/or using confidence levels will be described in further detail below. Persons skilled in the art, upon reviewing the entirety of this disclosure, will be aware of various ways in which confidence levels may be implemented, calculated, assigned, and/or used as consistent with methods and systems disclosed herein.

Still referring to FIG. 1, in some embodiments, digital tag 112 and/or a computing device in communication with digital tag 112 may generate digital access 128 of NFT 116. “Digital access” as used in this disclosure is an accessibility to a digital asset. Digital access 128 may include, but is not limited to, one or more cryptographic keys, digital signatures, one or more blocks of a blockchain, and the like. In some embodiments, digital access 128 may include a cryptographic link to a digital wallet. A “cryptographic link” as used in this disclosure is a secure communication between two or more computing devices. A cryptographic link may include, but is not limited to, one or more digital signatures, encrypted keys, passcodes, and the like. A “digital wallet” as used in this disclosure is an electronic application that supports digital transactions. Digital wallets may support cryptographic assets. A “cryptographic asset” as used in this disclosure are transferrable encrypted digital representations of one or more objects, items, and the like. Cryptographic assets may include digital representations of physical assets, such as physical asset 108. Digital access 128 may provide partial and/or full ownership of NFT 116. Partial ownership may include a shared ownership of NFT 116 among a plurality of users. Full ownership may include a sole ownership of a single user of NFT 116.

Still referring to FIG. 1, in some embodiments, system 100 may implement one or more unlocking protocols of NFT 116. An “unlocking protocol” as used in this disclosure is a process of granting access to one or more physical and/or digital assets to one or more users. In some embodiments, an unlocking protocol may include a current owner of NFT 116 posting a transaction on a blockchain of NFT 116 using a digital signature to declare NFT 116 is “unlocked.” A user may provide user input 120 through user device 136, such as, without limitation, tapping on a screen of user device 136. User input 120 may be compared to verification criterion 124 through digital tag 112 and/or a computing device in communication with digital tag 112, and may result in providing digital access 128 to a user of user device 136. In some embodiments, a current owner of NFT 116 may provide user input 120 which may include one or more screen taps which may results in a locking and/or unlocking of NFT 116 from other users. For instance and without limitation, a current owner may tap their smartphone, which may lock out NFT 116 from all other users. Continuing this example, a current owner of NFT 116 may tap their smartphone, which may unlock NFT 116, which may allow other users to potentially access NFT 116. A change in ownership of NFT 116 may be posted to a blockchain of NFT 116, which may show all or some of the previous owners of NFT 116. In some embodiments, one or more transfers of ownership of physical asset 108 and/or NFT 116 may be serialized. “Serialized” as used in this disclosure is a form of order in which data is arranged in a series. Transfers of ownership and/or transactional data of NFT 116 and/or physical asset 108 may be serialized in a blockchain, such that as soon as one transaction is added, other transactions may be rejected. In some embodiments, verification criterion 1224 may include an order of serialized data, such as blocks of a blockchain.

Still referring to FIG. 1, in some embodiments, digital access 128 may be provided by a “superuser” of NFT 116. A “superuser” as used in this disclosure is a user having unrestricted access to one or more NFTs. For instance and without limitation, a superuser may have credentials allowing the superuser to grant partial and/or full access of digital access 128 to one or more users. A superuser may provide one or more sub-keys to one or more users, restrict access of one or more users to NFT 116, remove access to NFT 116 from one or more users, and/or declare another superuser of NFT 116. In some embodiments, a superuser may tap a device, such as user device 136, which may unlock and/or transfer digital access 128 to one or more other user devices. In some embodiments, a superuser may unlock NFT 116 through tapping user device 136, which may declare NFT 116 is available to other users. One or more users may provide user input 120 in a form of tapping on a screen of user devices 136 to gain access to NFT 116 through digital access 128. In some embodiments, a superuser may set verification criterion 124 for digital access 128. For example, and without limitation, a superuser may specify a location, date, time, transaction value, and the like, for access to NFT 116. In some embodiments, a superuser may have a special credential, such as a digital signature, which may allow the superuser to reclaim NFT 116 and/or physical asset 108 at any time after a transfer of digital access 128 to one or more users. As a non-limiting example, a user may seek to return physical asset 108 and/or NFT 116 to a superuser. A superuser may have not had prior access and/or possession of NFT 116 and/or physical asset 108, however the superuser may have special credentials that may allow the superuser to receive NFT 116 and/or physical asset 108 from one or more users. Special credentials of a superuser may include one or more digital identifications, digital signatures, digital keys, biometric information, and the like. Special credentials may be received at specific computing devices having specific hardware identification and/or hardware signatures.

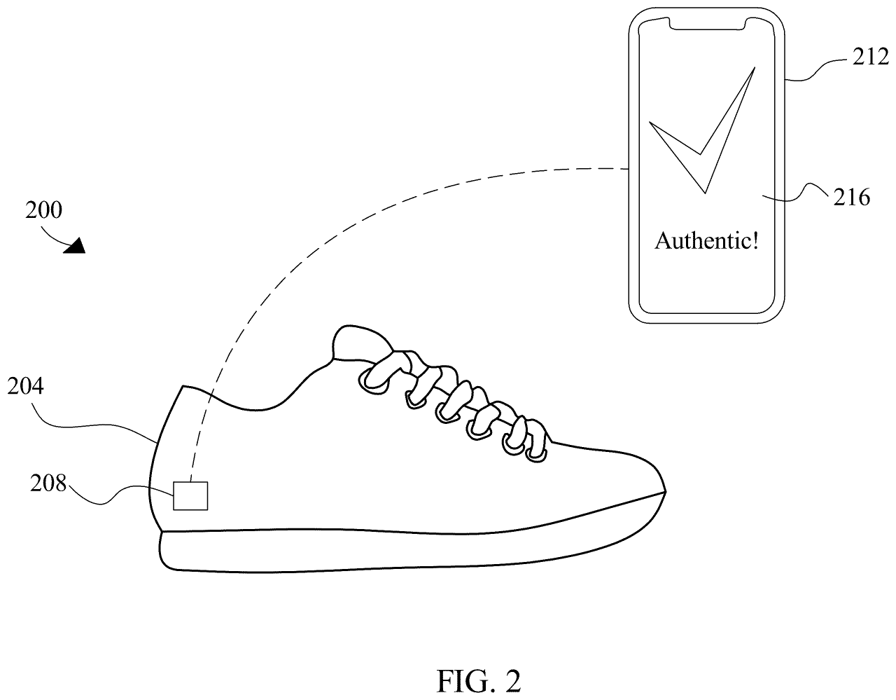

Referring now to FIG. 2, another exemplary embodiment of a system 200 for providing a user access to an NFT is presented. System 200 may include physical asset 204. Physical asset 204 may include physical assets as described above. In some embodiments, physical asset 204 may include a sneaker, shoe, and the like. Physical asset 204 may include digital tag 208. Digital tag 208 may include digital tag 112 as described above. Digital tag 208 may include an NFT representation of physical asset 204.

Still referring to FIG. 2, in some embodiments, digital tag 208 may be positioned on an exterior surface of physical asset 204. In some embodiments, digital tag 208 may be positioned inside an interior surface of physical asset 204. Digital tag 208 may be applied to physical asset 204 through, but not limited to, glue, sewing materials, stickers, and the like. In some embodiments, system 200 may include user device 212. User device 212 may include user device 136 as described above. In some embodiments, user device 212 may include a smartphone. User device 212 may receive and/or transmit one or more signals to digital tag 208. In other embodiments, digital tag 208 may include a QR code, which may be scanned by user device 212. User device 212 may display asset data 216 of physical asset 204 and/or digital tag 208 through a mobile application, weblink, and/or other forms of communication. Asset data 216 may include, without limitation, current owner, authenticity of physical asset 204, value of physical asset 204 and/or an NFT linked to physical asset 204, type of product of physical asset 204, last known location of physical asset 204, and the like. In some embodiments, user device 212 may display one or more transfer actions of physical asset 204. Transfer actions may include, but are not limited to, transferring partial ownership of physical asset 204, transferring entire ownership of physical asset 204, and the like.

Still referring to FIG. 2, in some embodiments, user device 212 may display multiple digital tags 208 to a user. For instance, and without limitation, there may be three digital tags 208 within a proximity to user device 212. Digital tag 208 may prompt user device 212 to display asset data 216 of each digital tag 208. A user may swipe through selections of nearby digital tags 208, which may modify communications with nearby digital tags 208. For instance and without limitation, a user may swipe through a first screen showing asset data of a first digital tag. This may cause first digital tag to cease communications with user device 212. In some embodiments, digital tag 208 may prompt directions to digital tag 208 to a user through user device 212. For instance and without limitation, digital tag 208 may display one or more arrows, maps, and/or other geographic signals to a user through user device 212 to guide a user to a certain proximity of digital tag 208, such as within a 1 ft radius of digital tag 208.

Referring now to FIG. 3, an exemplary embodiment of an immutable sequential listing 300 is illustrated. An “immutable sequential listing,” as used in this disclosure, is a data structure that places data entries in a fixed sequential arrangement, such as a temporal sequence of entries and/or blocks thereof, where the sequential arrangement, once established, cannot be altered or reordered. An immutable sequential listing may be, include and/or implement an immutable ledger, where data entries that have been posted to the immutable sequential listing cannot be altered. Data elements are listing in immutable sequential listing 300; data elements may include any form of data, including textual data, image data, encrypted data, cryptographically hashed data, and the like. Data elements may include, without limitation, one or more at least a digitally signed assertions. In one embodiment, a digitally signed assertion 304 is a collection of textual data signed using a secure proof as described in further detail below; secure proof may include, without limitation, a digital signature as described above. Collection of textual data may contain any textual data, including without limitation American Standard Code for Information Interchange (ASCII), Unicode, or similar computer-encoded textual data, any alphanumeric data, punctuation, diacritical mark, or any character or other marking used in any writing system to convey information, in any form, including any plaintext or cyphertext data; in an embodiment, collection of textual data may be encrypted, or may be a hash of other data, such as a root or node of a Merkle tree or hash tree, or a hash of any other information desired to be recorded in some fashion using a digitally signed assertion 304. In an embodiment, collection of textual data states that the owner of a certain transferable item represented in a digitally signed assertion 304 register is transferring that item to the owner of an address. A digitally signed assertion 304 may be signed by a digital signature created using the private key associated with the owner's public key, as described above.

Still referring to FIG. 3, a digitally signed assertion 304 may describe a transfer of virtual currency, such as crypto currency as described below. The virtual currency may be a digital currency. Item of value may be a transfer of trust, for instance represented by a statement vouching for the identity or trustworthiness of the first entity. Item of value may be an interest in a fungible negotiable financial instrument representing ownership in a public or private corporation, a creditor relationship with a governmental body or a corporation, rights to ownership represented by an option, derivative financial instrument, commodity, debt-backed security such as a bond or debenture or other security as described in further detail below. A resource may be a physical machine e.g. a ride share vehicle or any other asset. A digitally signed assertion 304 may describe the transfer of a physical good; for instance, a digitally signed assertion 304 may describe the sale of a product. In some embodiments, a transfer nominally of one item may be used to represent a transfer of another item; for instance, a transfer of virtual currency may be interpreted as representing a transfer of an access right; conversely, where the item nominally transferred is something other than virtual currency, the transfer itself may still be treated as a transfer of virtual currency, having value that depends on many potential factors including the value of the item nominally transferred and the monetary value attendant to having the output of the transfer moved into a particular user's control. The item of value may be associated with a digitally signed assertion 304 by means of an exterior protocol, such as the COLORED COINS created according to protocols developed by The Colored Coins Foundation, the MASTERCOIN protocol developed by the Mastercoin Foundation, or the ETHEREUM platform offered by the Stiftung Ethereum Foundation of Baar, Switzerland, the Thunder protocol developed by Thunder Consensus, or any other protocol.

Still referring to FIG. 3, in one embodiment, an address is a textual datum identifying the recipient of virtual currency or another item of value in a digitally signed assertion 304. In some embodiments, address is linked to a public key, the corresponding private key of which is owned by the recipient of a digitally signed assertion 304. For instance, address may be the public key. Address may be a representation, such as a hash, of the public key. Address may be linked to the public key in memory of a computing device, for instance via a “wallet shortener” protocol. Where address is linked to a public key, a transferee in a digitally signed assertion 304 may record a subsequent a digitally signed assertion 304 transferring some or all of the value transferred in the first a digitally signed assertion 304 to a new address in the same manner. A digitally signed assertion 304 may contain textual information that is not a transfer of some item of value in addition to, or as an alternative to, such a transfer. For instance, as described in further detail below, a digitally signed assertion 304 may indicate a confidence level associated with a distributed storage node as described in further detail below.

In an embodiment, and still referring to FIG. 3 immutable sequential listing 300 records a series of at least a posted content in a way that preserves the order in which the at least a posted content took place. Temporally sequential listing may be accessible at any of various security settings; for instance, and without limitation, temporally sequential listing may be readable and modifiable publicly, may be publicly readable but writable only by entities and/or devices having access privileges established by password protection, confidence level, or any device authentication procedure or facilities described herein, or may be readable and/or writable only by entities and/or devices having such access privileges. Access privileges may exist in more than one level, including, without limitation, a first access level or community of permitted entities and/or devices having ability to read, and a second access level or community of permitted entities and/or devices having ability to write; first and second community may be overlapping or non-overlapping. In an embodiment, posted content and/or immutable sequential listing 300 may be stored as one or more zero knowledge sets (ZKS), Private Information Retrieval (PIR) structure, or any other structure that allows checking of membership in a set by querying with specific properties. Such database may incorporate protective measures to ensure that malicious actors may not query the database repeatedly in an effort to narrow the members of a set to reveal uniquely identifying information of a given posted content.

Still referring to FIG. 3, immutable sequential listing 300 may preserve the order in which the at least a posted content took place by listing them in chronological order; alternatively or additionally, immutable sequential listing 300 may organize digitally signed assertions 304 into sub-listings 308 such as “blocks” in a blockchain, which may be themselves collected in a temporally sequential order; digitally signed assertions 304 within a sub-listing 308 may or may not be temporally sequential. The ledger may preserve the order in which at least a posted content took place by listing them in sub-listings 308 and placing the sub-listings 308 in chronological order. The immutable sequential listing 300 may be a distributed, consensus-based ledger, such as those operated according to the protocols promulgated by Ripple Labs, Inc., of San Francisco, Calif., or the Stellar Development Foundation, of San Francisco, Calif, or of Thunder Consensus. In some embodiments, the ledger is a secured ledger; in one embodiment, a secured ledger is a ledger having safeguards against alteration by unauthorized parties. The ledger may be maintained by a proprietor, such as a system administrator on a server, that controls access to the ledger; for instance, the user account controls may allow contributors to the ledger to add at least a posted content to the ledger, but may not allow any users to alter at least a posted content that have been added to the ledger. In some embodiments, ledger is cryptographically secured; in one embodiment, a ledger is cryptographically secured where each link in the chain contains encrypted or hashed information that makes it practically infeasible to alter the ledger without betraying that alteration has taken place, for instance by requiring that an administrator or other party sign new additions to the chain with a digital signature. Immutable sequential listing 300 may be incorporated in, stored in, or incorporate, any suitable data structure, including without limitation any database, datastore, file structure, distributed hash table, directed acyclic graph or the like. In some embodiments, the timestamp of an entry is cryptographically secured and validated via trusted time, either directly on the chain or indirectly by utilizing a separate chain. In one embodiment the validity of timestamp is provided using a time stamping authority as described in the RFC 3161 standard for trusted timestamps, or in the ANSI ASC x9.95 standard. In another embodiment, the trusted time ordering is provided by a group of entities collectively acting as the time stamping authority with a requirement that a threshold number of the group of authorities sign the timestamp.

In some embodiments, and with continued reference to FIG. 3, immutable sequential listing 300, once formed, may be inalterable by any party, no matter what access rights that party possesses. For instance, immutable sequential listing 300 may include a hash chain, in which data is added during a successive hashing process to ensure non-repudiation. Immutable sequential listing 300 may include a block chain. In one embodiment, a block chain is immutable sequential listing 300 that records one or more new at least a posted content in a data item known as a sub-listing 308 or “block.” An example of a block chain is the BITCOIN block chain used to record BITCOIN transactions and values. Sub-listings 308 may be created in a way that places the sub-listings 308 in chronological order and link each sub-listing 308 to a previous sub-listing 308 in the chronological order so that any computing device may traverse the sub-listings 308 in reverse chronological order to verify any at least a posted content listed in the block chain. Each new sub-listing 308 may be required to contain a cryptographic hash describing the previous sub-listing 308. In some embodiments, the block chain contains a single first sub-listing 308 sometimes known as a “genesis block.”

Still referring to FIG. 3, the creation of a new sub-listing 308 may be computationally expensive; for instance, the creation of a new sub-listing 308 may be designed by a “proof of work” protocol accepted by all participants in forming the immutable sequential listing 300 to take a powerful set of computing devices a certain period of time to produce. Where one sub-listing 308 takes less time for a given set of computing devices to produce the sub-listing 308 protocol may adjust the algorithm to produce the next sub-listing 308 so that it will require more steps; where one sub-listing 308 takes more time for a given set of computing devices to produce the sub-listing 308 protocol may adjust the algorithm to produce the next sub-listing 308 so that it will require fewer steps. As an example, protocol may require a new sub-listing 308 to contain a cryptographic hash describing its contents; the cryptographic hash may be required to satisfy a mathematical condition, achieved by having the sub-listing 308 contain a number, called a nonce, whose value is determined after the fact by the discovery of the hash that satisfies the mathematical condition. Continuing the example, the protocol may be able to adjust the mathematical condition so that the discovery of the hash describing a sub-listing 308 and satisfying the mathematical condition requires more or less steps, depending on the outcome of the previous hashing attempt. Mathematical condition, as an example, might be that the hash contains a certain number of leading zeros and a hashing algorithm that requires more steps to find a hash containing a greater number of leading zeros, and fewer steps to find a hash containing a lesser number of leading zeros. In some embodiments, production of a new sub-listing 308 according to the protocol is known as “mining.” The creation of a new sub-listing 308 may be designed by a “proof of stake” protocol as will be apparent to those skilled in the art upon reviewing the entirety of this disclosure.

Continuing to refer to FIG. 3, in some embodiments, protocol also creates an incentive to mine new sub-listings 308. The incentive may be financial; for instance, successfully mining a new sub-listing 308 may result in the person or entity that mines the sub-listing 308 receiving a predetermined amount of currency. The currency may be fiat currency. Currency may be cryptocurrency as defined below. In other embodiments, incentive may be redeemed for particular products or services; the incentive may be a gift certificate with a particular business, for instance. In some embodiments, incentive is sufficiently attractive to cause participants to compete for the incentive by trying to race each other to the creation of sub-listings 308 Each sub-listing 308 created in immutable sequential listing 300 may contain a record or at least a posted content describing one or more addresses that receive an incentive, such as virtual currency, as the result of successfully mining the sub-listing 308.

With continued reference to FIG. 3, where two entities simultaneously create new sub-listings 308, immutable sequential listing 300 may develop a fork; protocol may determine which of the two alternate branches in the fork is the valid new portion of the immutable sequential listing 300 by evaluating, after a certain amount of time has passed, which branch is longer. “Length” may be measured according to the number of sub-listings 308 in the branch. Length may be measured according to the total computational cost of producing the branch. Protocol may treat only at least a posted content contained the valid branch as valid at least a posted content. When a branch is found invalid according to this protocol, at least a posted content registered in that branch may be recreated in a new sub-listing 308 in the valid branch; the protocol may reject “double spending” at least a posted content that transfer the same virtual currency that another at least a posted content in the valid branch has already transferred. As a result, in some embodiments the creation of fraudulent at least a posted content requires the creation of a longer immutable sequential listing 300 branch by the entity attempting the fraudulent at least a posted content than the branch being produced by the rest of the participants; as long as the entity creating the fraudulent at least a posted content is likely the only one with the incentive to create the branch containing the fraudulent at least a posted content, the computational cost of the creation of that branch may be practically infeasible, guaranteeing the validity of all at least a posted content in the immutable sequential listing 300.

Still referring to FIG. 3, additional data linked to at least a posted content may be incorporated in sub-listings 308 in the immutable sequential listing 300; for instance, data may be incorporated in one or more fields recognized by block chain protocols that permit a person or computer forming a at least a posted content to insert additional data in the immutable sequential listing 300. In some embodiments, additional data is incorporated in an unspendable at least a posted content field. For instance, the data may be incorporated in an OP_RETURN within the BITCOIN block chain. In other embodiments, additional data is incorporated in one signature of a multi-signature at least a posted content. In an embodiment, a multi-signature at least a posted content is at least a posted content to two or more addresses. In some embodiments, the two or more addresses are hashed together to form a single address, which is signed in the digital signature of the at least a posted content. In other embodiments, the two or more addresses are concatenated. In some embodiments, two or more addresses may be combined by a more complicated process, such as the creation of a Merkle tree or the like. In some embodiments, one or more addresses incorporated in the multi-signature at least a posted content are typical crypto currency addresses, such as addresses linked to public keys as described above, while one or more additional addresses in the multi-signature at least a posted content contain additional data related to the at least a posted content; for instance, the additional data may indicate the purpose of the at least a posted content, aside from an exchange of virtual currency, such as the item for which the virtual currency was exchanged. In some embodiments, additional information may include network statistics for a given node of network, such as a distributed storage node, e.g. the latencies to nearest neighbors in a network graph, the identities or identifying information of neighboring nodes in the network graph, the trust level and/or mechanisms of trust (e.g. certificates of physical encryption keys, certificates of software encryption keys, (in non-limiting example certificates of software encryption may indicate the firmware version, manufacturer, hardware version and the like), certificates from a trusted third party, certificates from a decentralized anonymous authentication procedure, and other information quantifying the trusted status of the distributed storage node) of neighboring nodes in the network graph, IP addresses, GPS coordinates, and other information informing location of the node and/or neighboring nodes, geographically and/or within the network graph. In some embodiments, additional information may include history and/or statistics of neighboring nodes with which the node has interacted. In some embodiments, this additional information may be encoded directly, via a hash, hash tree or other encoding.

With continued reference to FIG. 3, in some embodiments, virtual currency is traded as a crypto currency. In one embodiment, a crypto currency is a digital, currency such as Bitcoins, Peercoins, Namecoins, and Litecoins. Crypto currency may be a clone of another crypto currency. The crypto currency may be an “alt-coin.” Crypto currency may be decentralized, with no particular entity controlling it; the integrity of the crypto currency may be maintained by adherence by its participants to established protocols for exchange and for production of new currency, which may be enforced by software implementing the crypto currency. Crypto currency may be centralized, with its protocols enforced or hosted by a particular entity. For instance, crypto currency may be maintained in a centralized ledger, as in the case of the XRP currency of Ripple Labs, Inc., of San Francisco, Calif. In lieu of a centrally controlling authority, such as a national bank, to manage currency values, the number of units of a particular crypto currency may be limited; the rate at which units of crypto currency enter the market may be managed by a mutually agreed-upon process, such as creating new units of currency when mathematical puzzles are solved, the degree of difficulty of the puzzles being adjustable to control the rate at which new units enter the market. Mathematical puzzles may be the same as the algorithms used to make productions of sub-listings 308 in a block chain computationally challenging; the incentive for producing sub-listings 308 may include the grant of new crypto currency to the miners. Quantities of crypto currency may be exchanged using at least a posted content as described above.

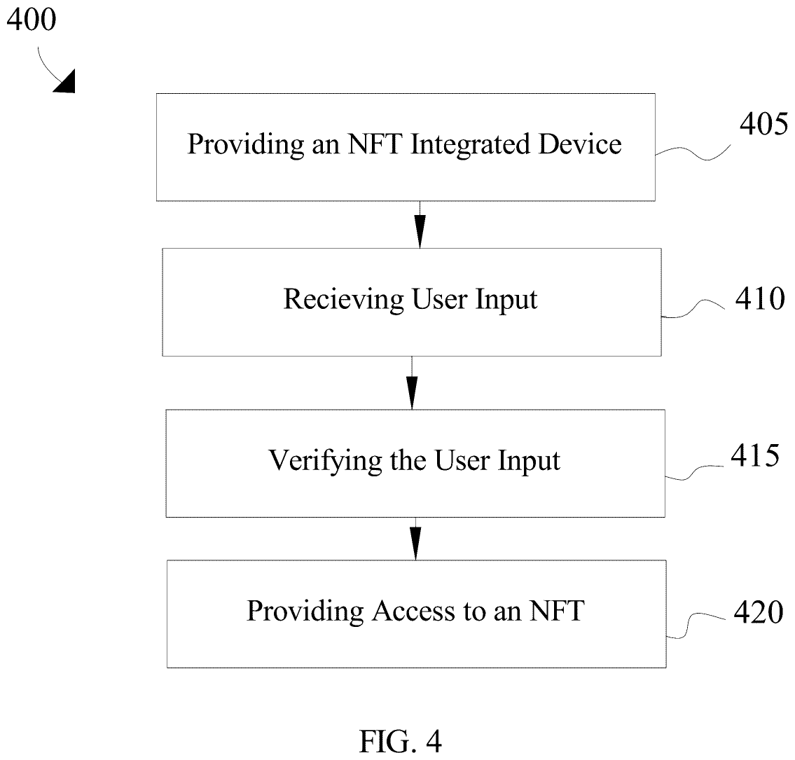

Referring now to FIG. 4, a method 400 of providing NFT access is presented. At step 405, method 400 includes providing an NFT integrated device. An NFT integrated device may include a digital tag coupled to a physical asset. A digital tag may include an NFT representative of a physical asset. In some embodiments, a digital tag may be coupled to a physical asset through a securing mechanism. An NFT integrated device may include, but is not limited to, articles of clothing, forms of art, and the like. This step may be implemented, without limitation, as described above with reference to FIGS. 1-3.

Still referring to FIG. 4, at step 410, method 400 includes receiving user input. User input may be received through an NFT integrated device. In some embodiments, user input may be communicated to an NFT integrated device from a user device. User input may include, but is not limited to, interactions with one or more icons on a GUI, swiping gestures, touch inputs, and the like. This step may be implemented, without limitation, as described above with reference to FIGS. 1-3.

Still referring to FIG. 4, at step 415, method 400 includes verifying user input as a function of a verification criterion. Verifying user input may include comparing the user input to one or more verification criteria. This step may be implemented, without limitation, as described above with reference to FIGS. 1-3.

Still referring to FIG. 4, at step 420, method 400 includes providing access to an NFT. Access may be provided through a cryptographic link to a digital wallet. This step may be implemented, without limitation, as described above with reference to FIGS. 1-3.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

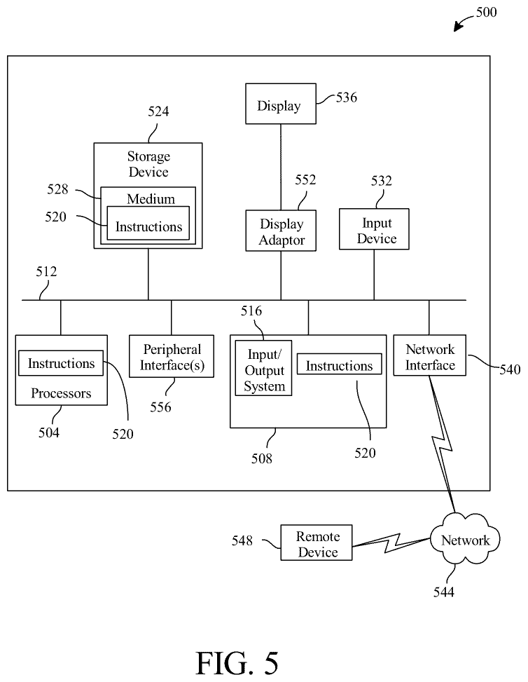

FIG. 5 shows a diagrammatic representation of one embodiment of a computing device in the exemplary form of a computer system 500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Still referring to FIG. 5, processor 504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 504 may be organized according to Von Neumann and/or Harvard architecture as a non-limiting example. Processor 504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Still referring to FIG. 5, memory 508 may include various components (e.g., machine-readable media) including, but not limited to, a random-access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Still referring to FIG. 5, computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Still referring to FIG. 5, computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

Still referring to FIG. 5, a user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Still referring to FIG. 5, computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for providing non-fungible token (NFT) access to a user, comprising:
an NFT integrated device, wherein the NFT integrated device comprises:
a physical asset;
a digital tag linked to an NFT of the physical asset; and
a securing mechanism coupling the digital tag into at least a portion of the physical asset; and
wherein the NFT integrated device is configured to:
receive user input from a user;
verify the user input as a function of a verification criterion; and
provide access to the NFT of the physical asset to the user as a function of the verification of the user input.

2. The system of claim 1, wherein the NFT integrated device is further configured to lock access to the NFT of the physical asset as a function of the verification of the user input.

3. The system of claim 1, wherein the user input includes a tap received through the NFT integrated device.

4. The system of claim 1, wherein providing access to the NFT of the physical asset comprises providing a cryptographic link of a digital wallet to the user.

5. The system of claim 1, wherein the NFT integrated device is further configured to display an authenticity of the physical asset on a user device.

6. The system of claim 1, wherein the verification criterion includes a digital signature of the user.

7. The system of claim 1, wherein the NFT integrated device is further configured to transfer access to the NFT of the physical asset from the user to a second user as a function of the verification of the user input.

8. The system of claim 1, wherein the verification criterion includes a proximity.

9. The system of claim 1, wherein the digital tag is configured to provide haptic feedback to the user as a function of the verification.

10. The system of claim 1, wherein the securing mechanism is configured to damage the NFT integrated device upon an unauthorized removal of the digital tag from the NFT integrated device.

11. A method of providing non-fungible token (NFT) access to a user, comprising:
providing an NFT integrated device;
receiving user input through the NFT integrated device;
verifying the user input as a function of a verification criterion; and
providing access to access to an NFT linked to a physical asset of the NFT integrated device to a user as a function of the verification.

12. The method of claim 11, further comprising locking access to the NFT of the physical asset as a function of the verification of the user input.

13. The method of claim 11, wherein the user input includes a tap input received through the NFT integrated device.

14. The method of claim 11, wherein providing access to the NFT of the physical asset comprises providing a cryptographic link of a digital wallet to the user.

15. The method of claim 11, wherein the user input comprises touch input of a touchscreen of a user device.

16. The method of claim 11, wherein the verification criterion includes a digital signature of an authenticated user.

17. The method of claim 11, further comprising transferring access to the NFT of the physical asset from a first user to a second user.

18. The method of claim 11, wherein verifying further comprises authenticating the verification criterion through a plurality of validator nodes.

19. The method of claim 11, further comprises providing haptic feedback to a user as a function of the verification.

20. The method of claim 11, further comprising securing the digital tag to the physical asset of the NFT integrated device through a securing mechanism, wherein the securing mechanism is configured to damage the NFT integrated device upon unauthorized removal of a digital tag from the NFT integrated device.
